(19) United States
(12) Patent Application Publication
(10) Pub. No.: US 2025/0137821 A1
(43) Pub. Date: May 1, 2025

(54) METHOD, APPARATUS AND COMPUTER-READABLE MEDIUM FOR MONITORING ABNORMAL CONDITION BASED ON MULTI SENSOR

(71) Applicant: SKAIChips Co., Ltd., Suwon-si (KR)

(72) Inventors: Kang Yoon LEE, Seoul (KR); Sung June BYUN, Suwon-si (KR); Jong Wan JO, Suwon-si (KR); Ji Hoon SONG, Suwon-si (KR); Young Gun PU, Suwon-si (KR)

(73) Assignee: SKAIChips Co., Ltd., Suwon-si (KR)

(21) Appl. No.: 18/398,153

(22) Filed: Dec. 28, 2023

(30) Foreign Application Priority Data
Oct. 25, 2023 (KR) 10-2023-0143930

(51) Int. Cl. G01D 18/00; G01D 21/02

(52) U.S. Cl. CPC G01D 18/00; G01D 21/02; G01D 2218/10

(57) ABSTRACT

A method of monitoring an abnormal condition based on multiple sensors includes processing sensing signals received from a plurality of sensors configured to detect different objects and outputting sensing data obtained by converting the sensing signals into digital signals, generating input data to be input to a neural network model by variably adjusting a size of the sensing data, performing an operation in an analog domain on the input data using the neural network mode and outputting operation data obtained by converting an operation result into digital data, and outputting a monitoring result obtained by classifying an abnormal condition based on the operation data.

### BACKGROUND OF THE INVENTION

### Field of the Invention

The present disclosure relates to a method, apparatus and computer-readable medium for monitoring an abnormal condition based on multiple sensors.

### Description of the Related Art

With advancement of electronics and communication technologies, various IoT (Internet of Things) sensor devices have been employed in various fields. The IoT sensor devices are installed in various environments and locations such as smart homes, factories, public places, and roads to sense various external environments.

An IoT sensor device senses an external environment by including a sensor, a processor, and a communication chipset therein, and processes the sensed data or transmits the sensed data to the outside through the communication chipset.

An IoT system may receive and process sensed data from a plurality of IoT sensors. In this instance, when information is processed by connecting one sensor to one circuit, it is inevitable that the device size will increase in order to obtain one piece of information through information of several sensors, and thus the design cost may increase. Accordingly, research is needed on a method of processing signals so that multiple sensors may be processed in one circuit.

The above-mentioned background technology is technical information possessed by the inventor to derive the present invention or acquired in a process of deriving the present invention, and cannot necessarily be regarded as known technology disclosed to the general public before filing the application for the present invention.

### SUMMARY OF THE INVENTION

Some embodiments according to the present disclosure provide a method, apparatus and computer-readable medium for monitoring an abnormal condition based on multiple sensors. The tasks to be solved by the present invention are not limited to the above-mentioned tasks, and other tasks and advantages of the present invention not mentioned herein may be understood through the following description and may be understood more clearly by the embodiments of the present invention. In addition, it can be seen that the tasks and advantages to be solved by the present invention may be realized by the means and combinations thereof indicated in the patent claims.

As a technical means for achieving the above-described technical task, a first aspect of the present disclosure is a method of monitoring an abnormal condition based on multiple sensors including processing sensing signals received from a plurality of sensors configured to detect different objects and outputting sensing data obtained by converting the sensing signals into digital signals, generating input data to be input to a neural network model by variably adjusting a size of the sensing data, performing an operation in an analog domain on the input data using the neural network mode and outputting operation data obtained by converting an operation result into digital data, and outputting a monitoring result obtained by classifying an abnormal condition based on the operation data.

A second aspect of the present disclosure is an abnormal condition monitoring device based on multiple sensors including a memory configured to store at least one program, and a processor configured to execute the at least one program, wherein the processor is configured to process sensing signals received from a plurality of sensors configured to detect different objects and outputting sensing data obtained by converting the sensing signals into digital signals, generate input data to be input to a neural network model by variably adjusting a size of the sensing data, perform an operation in an analog domain on the input data using the neural network mode and output operation data obtained by converting an operation result into digital data, and output a monitoring result obtained by classifying an abnormal condition based on the operation data.

A third aspect of the present disclosure is a computer-readable recording medium on which is stored a program for executing the method according to the first aspect on a computer.

In addition, another method for implementing the present invention, another system, and a computer-readable recording medium storing a computer program for executing the method may be further provided.

Other aspects, features and advantages in addition to those described above will become apparent from the following drawings, claims, and detailed description of the invention.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a monitoring system including a sensor device according to an embodiment;

FIG. 2 is a block diagram illustrating an example of an internal configuration of a signal processing circuit according to an embodiment;

FIGS. 3a and 3b are block diagrams illustrating examples of internal configurations of a power supply and a sensor signal processor according to an embodiment;

FIG. 4 is a block diagram illustrating an example of an internal configuration of an analog PIM module according to an embodiment;

FIGS. 5a, 5b and 5c are diagrams for describing an internal structure and an operation of an analog PIM according to an embodiment;

FIG. 6 is a diagram for describing an example of an analog PIM controller according to an embodiment;

FIG. 7 is a flowchart for describing an illustrative control flow for determining output and computational resolution matching any sensor according to an embodiment;

FIG. 8 is a diagram for describing an example of a system for monitoring an abnormal condition based on multiple sensors according to an embodiment;

FIG. 9 is a diagram for describing an example of an internal configuration of a monitoring device according to an embodiment;

FIG. 10 is a diagram for describing another example of the internal configuration of the monitoring device according to an embodiment;

FIG. 11 is a flowchart for describing an example of a method of monitoring an abnormal condition based on multiple sensors according to an embodiment;

FIG. 12 is a diagram for describing examples of sensing data according to an embodiment;

FIG. 13 is a diagram for describing examples of input data according to an embodiment;

FIG. 14 is a flowchart for describing another example of the method of monitoring an abnormal condition based on multiple sensors according to an embodiment; and

FIG. 15 is a diagram for describing other examples of the sensing data according to an embodiment.

### DETAILED DESCRIPTION OF THE INVENTION

The advantages and features of the present invention and methods for achieving the advantages and features will become clear by referring to the embodiments described in detail together with the accompanying drawings. However, the present invention is not limited to the embodiments presented below, and may be implemented in various different forms, and it should be understood that the present invention contains all conversions, equivalents, and substitutes included in the spirit and technical scope of the present invention. The embodiments presented below are provided to ensure that the disclosure of the present invention is complete and to fully inform those skilled in the art of the scope of the invention. In describing the present invention, when it is determined that a detailed description of related known technologies may obscure the gist of the present invention, the detailed description will be omitted.

The terms used in this application are only used to describe specific embodiments and are not intended to limit the invention. Singular expressions include plural expressions unless the context clearly dictates otherwise. In this application, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

Some embodiments of the present disclosure may be represented by functional block configurations and various processing steps. Some or all of these functional blocks may be implemented in various numbers of hardware and/or software configurations that perform specific functions. For example, the functional blocks of the present disclosure may be implemented by one or more microprocessors or by circuit configurations for certain functions. In addition, for example, functional blocks of the present disclosure may be implemented in various programming or scripting languages. Functional blocks may be implemented as algorithms executed on one or more processors. In addition, the present disclosure may employ conventional technologies for electronic environment setup, signal processing, and/or data processing. Terms such as “mechanism,” “element,” “means,” and “configuration” may be broadly used and are not limited to mechanical and physical components.

Further, connection lines or connection members between components shown in the drawings merely illustrate functional connections and/or physical or circuit connections. In an actual device, connections between components may be represented by various replaceable or additional functional connections, physical connections, or circuit connections.

In this specification, a “neural network model” may refer to a deep learning model based on an artificial neural network (ANN). The deep learning model has a deep structure having several hidden layers in the ANN, through which complex patterns may be learned. For example, the deep learning model may include an input layer, a hidden layer, and an output layer, and each layer may include several neurons. In addition, each neuron may calculate an output value by applying an input value multiplied by a weight to an activation function, each layer transmits a signal to the next layer, and the signal may be adjusted through the weight and bias. In other words, the deep learning model uses training data to optimize weights and biases, which allows a complex relationship between input and output to be learned. Meanwhile, the deep learning model may be implemented with various types of models, such as Multi-Layer Perceptron (MLP), Convolutional Neural Network (CNN), and Recurrent Neural Network (RNN). In addition, the deep learning model may be implemented as various models depending on the method of configuring an activation function, a loss function, an optimization algorithm, etc., and will not be limited to a specific type of model.

In the following, the embodiments will be described in detail with reference to the attached drawings. However, the embodiments may be implemented in various different forms and are not limited to the examples described herein.

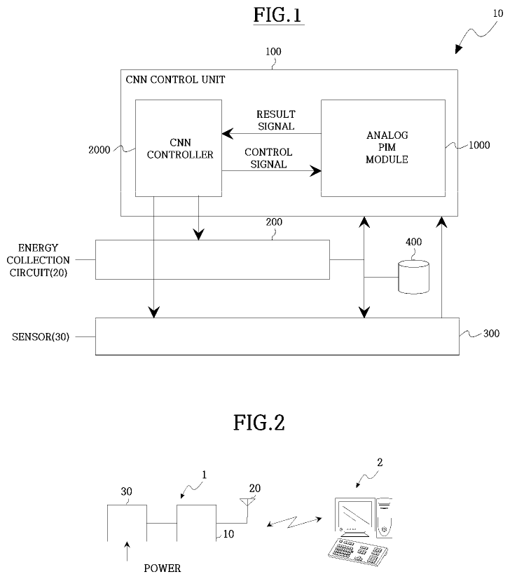

FIG. 1 is a diagram illustrating a monitoring system including a sensor device 1 according to an embodiment.

The sensor device 1 according to the present invention includes a signal processing circuit 10, a sensor 30, and an energy collection circuit 20. The sensor 30 is a device for sensing of the external environment at the location where the sensor device 1 is installed, and for example, senses temperature, humidity, or images. The sensor 30 is connected to the signal processing circuit 10, operates according to the power supplied from the signal processing circuit 10, and outputs a sensing signal to the signal processing circuit 10. The sensor 30 connected to the signal processing circuit 10 may be various types of sensors.

The energy collection circuit 20 collects energy from the environment outside the sensor device 1. The energy collection circuit 20 includes an RF antenna, a resonance coil, a solar cell, and/or a static electricity collection circuit, and may collect energy (power) from an RF signal, a resonance signal, solar heat, and/or static electricity available as an energy source.

The signal processing circuit 10 generates and stores power through the energy collection circuit 20 and supplies the generated power to the sensor 30. In addition, the signal processing circuit 10 may receive a sensing signal from the sensor 30 and process the sensing signal. For example, the signal processing circuit 10 may determine the condition of the sensor 30 or the state of the outside of the sensor device 1 by processing the sensing signal.

The signal processing circuit 10 according to the present invention applies CNN (Convolution Neural Network) algorithm technology to generate optimal power from various power sources (RF signal, resonance signal, solar power, and/or static electricity) and to perform processing on the sensing signal, etc. The signal processing circuit 10 is configured to be able to perform convolution calculation in the analog domain by including a scalable analog PIM module 1000 (or analog PIM 1100) that may dynamically increase or decrease the computational resolution according to the present invention.

The signal processing circuit 10 including the scalable analog PIM module 1000 (or analog PIM 1100) may provide variable processing performance required for various types of sensors 30 by adjusting the computational resolution, which results in optimal power consumption efficiency. The signal processing circuit 10 is configured to be universally applicable to various sensors 30. The signal processing circuit 10 includes a self-power generation circuit using various power sources, and thus may be free from environmental constraints related to external power supply. The signal processing circuit 10 is preferably configured as an integrated circuit. The signal processing circuit 10 may be integrated into a semiconductor in a package made of plastic or metal and mounted on a board of the sensor device 1. The signal processing circuit 10 will be examined in detail in FIG. 2 and thereafter.

A control terminal 2 of the monitoring system is a terminal for control of the sensor device 1 (specifically, the signal processing circuit 10). The control terminal 2, which may be configured as a personal computer, a cloud server, etc., updates a weight (weight of a filter or kernel) of a CNN algorithm processed by the signal processing circuit 10 or sets a parameter for setting of accuracy, efficiency, etc. of the CNN algorithm or other processing. The control terminal 2 and the sensor device 1 may be connected by wire (for example, USB, etc.) or wirelessly (for example, Wi-Fi or ZigBee, etc.) to update or change settings, parameters, weights, etc. of the sensor device 1 under the control of the control terminal 2.

FIG. 2 is a block diagram illustrating an internal configuration of the signal processing circuit 10.

According to FIG. 2, the signal processing circuit 10 includes a CNN control unit 100, a power supply 200, a sensor signal processor 300, and an energy storage unit 400. The signal processing circuit 10 may further include blocks other than the hardware blocks shown in FIG. 2.

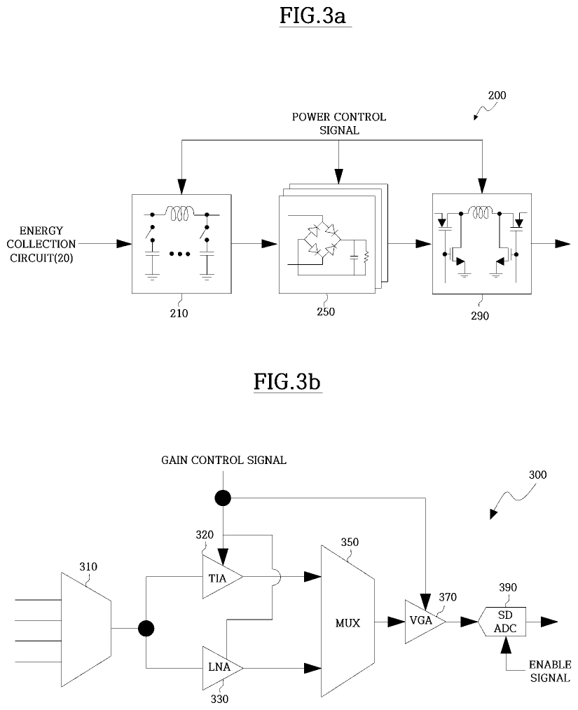

The power supply 200 generates power from a signal outside the sensor device 1. The power supply 200 is connected to the energy collection circuit 20 of the sensor device 1 to generate and output power from an RF signal, a resonance signal, solar heat, and/or a static electricity signal from the energy collection circuit 20 under the control of the CNN control unit 100. The power supply 200 will be examined more with reference to FIG. 3.

The sensor signal processor 300 processes a sensing signal from the sensor 30. The sensor signal processor 300 processes a sensing signal from an arbitrary sensor 30 under the control of the CNN control unit 100 and outputs processed sensing data.

The energy storage unit 400 stores power generated by the power supply 200. The energy storage unit 400 may include a known storage element for storage of power or may include a cap. The power stored in the energy storage unit 400 (and further, the power generated by the current power supply 200) is supplied to other blocks (the CNN control unit 100, the sensor signal processor 300, and the power supply 200).

The CNN control unit 100 controls the power supply 200 and the sensor signal processor 300 according to workload data of the power source generated by the power supply 200 and sensing data generated by the sensor signal processor 300. The CNN control unit 100 includes a CNN controller 2000 and the scalable analog PIM module 1000. The workload data may be data indicating the amount of current of the generated power.

The analog PIM module 1000 performs a convolution operation between weight and input data (workload data and/or sensing data) in the analog signal domain, performs conversion into digital convolution data, and outputs the digital convolution data as a result signal. The analog PIM module 1000 operates according to the control (control signal) of the CNN controller 2000 and may preferably perform a convolution operation by variably setting the size of the weight and the size of the input data.

In other words, the analog PIM module 1000 may reduce power consumption required for analog operation and further improve operation speed through optimization to an efficient operation size for processing input data. The resolution of data required for processing sensing data from various sensors 30, such as temperature, humidity, and image, may be different for each sensor 30. The analog PIM module 1000 according to the present invention is configured to be able to dynamically perform an efficient operation or detect input resolution according to data characteristics of the combined sensor 30 and to perform an analog convolution operation at the corresponding operation or input resolution.

The CNN controller 2000 of the CNN control unit 100 executes a CNN artificial intelligence algorithm (AI) to control the power supply 200 and/or the sensor signal processor 300 by controlling the analog PIM module 1000. The CNN controller 2000 may include an MCU (for example, Low Power MCU), a memory, and a circuit or logic for extraction and classification of features.

The CNN control unit 100 may determine the condition of the sensor 30 according to execution of the CNN AI algorithm using the scalable analog PIM module 1000. In addition, the CNN control unit 100 generates a power control signal for control of the power supply 200 and a gain control signal for control of the gain of the sensor signal processor 300 from workload data and sensing data according to the (technology of) CNN AI algorithm using the scalable analog PIM module 1000, and outputs the power control signal to the power supply 200 and the sensor signal processor 300.

The CNN control unit 100 may process subsequent layers after processing a layer for input data according to the CNN AI algorithm to generate a power control signal and a gain control signal according to classification, and may determine various other conditions.

FIG. 3 is a block diagram illustrating examples of configurations of the power supply 200 and the sensor signal processor 300.

FIG. 3A illustrates an example hardware block diagram of the power supply 200, and FIG. 3B illustrates an example hardware block diagram of the sensor signal processor 300. The examples of FIG. 3 are diagrams illustrating configurations for understanding the present invention, and the sensor device 1 may have various or different configurations of the power supply 200 and the sensor signal processor 300, which are known or will be known.

When the power supply 200 and the sensor signal processor 300 are briefly examined with reference to FIG. 3, the power supply 200 includes an adaptive matching network 210, one or more rectifiers 250, and one or more DC-DC converters 290. The adaptive matching network 210 is configured to optimally match one or more of an RF signal, a resonance signal, a solar signal, and/or an electrostatic signal according to a received power control signal. The CNN control unit 100 may output a power control signal that allows the adaptive matching network 210 to match a specific power source.

The rectifier 250 is coupled to the adaptive matching network 210 to generate direct current (DC) power from a signal from the adaptive matching network 210. The rectifier 250 may be, for example, a full-bridge rectifier or a half-bridge rectifier. The one or more rectifiers 250 operate according to a power control signal received from the CNN control unit 100 to generate and output DC power.

The DC-DC converter 290 is connected to the rectifier 250 and to boost or reduce DC power from the rectifier 250 according to a set voltage. The DC-DC converter 290 may be, for example, a buck-booster converter. The DC-DC converter 290 may operate according to a power control signal received from the CNN control unit 100 and output DC power at a set level.

Here, the power control signal received from the CNN control unit 100 is a signal for control of the adaptive matching network 210, the one or more rectifiers 250, and the one or more DC-DC converters 290 by performing a CNN AI algorithm on the workload data (current amount data) of the DC power output from the power supply 200. The CNN control unit 100 generates and outputs a power control signal for optimal control of the power supply 200 for currently input workload data (further using sensing data).

The sensor signal processor 300 includes a first MUX 310 (multiplex), a TIA (Trans Impedance Amp) 320, an LNA (Low Noise Amp) 330, a second MUX 350, a VGA (Variable Gain Amp) 370, and an SD ADC (Sensor Device ADC) 390. The first MUX 310 outputs a signal of one sensor signal line among a plurality of sensor signal lines according to an applied selection signal. For example, the first MUX 310 may output a signal of a sensor signal line of one of four pins connectable to the sensor 30 of the integrated circuit, which is the signal processing circuit 10, according to a signal applied to a pin of a selection signal.

The TIA 320 is connected to the first MUX 310, amplifies a signal from the first MUX 310, and outputs the amplified signal. The TIA 320 amplifies and outputs an input signal according to a gain control signal received from the CNN control unit 100. For example, the TIA 320 may convert a current signal into a voltage signal, and amplify and output the converted voltage signal according to an applied gain control signal.

The LNA 330 is connected to the first MUX 310 to amplify a signal from the first MUX 310 and output the amplified signal. The LNA 330 may amplify an input voltage signal according to a gain control signal received from the CNN control unit 100 and output the amplified voltage signal.

The second MUX 350 is connected to the TIA 320 and the LNA 330 to select and output an amplified signal from the TIA 320 or an amplified signal from the LNA 330. The second MUX 350 may output one signal according to the same selection signal as a pin of a selection signal of the first MUX 310, or may output one signal according to a selection signal received from the CNN control unit 100.

The VGA 370 is connected to the second MUX 350 to amplify a signal from the second MUX 350 according to a gain control signal.

The SD ADC 390 is connected to the VGA 370, converts an analog signal from the VGA 370 into a digital signal, and outputs converted sensing data. The SD ADC 390 may be a successive approximation ADC that includes SAR logic, a CDAC, and a comparator.

The SD ADC 390 has a maximum resolution of 8 bits, 16 bits, or 32 bits and outputs converted digital sensing data within the maximum resolution. The SD ADC 390 receives an enable signal specifying the number of bits enabled within the maximum resolution from the analog PIM module 1000 or the CNN control unit 100, and outputs digital sensing data having an output resolution corresponding to the number of bits enabled within the maximum resolution according to the enable signal.

For example, when the maximum bit resolution of the SD ADC 390 is 16 bits and the SDADC 390 receives an 8-bit enable signal, scaling to 8 bits is performed to output digital sensing data. When the SD ADC 390 receives an enable signal requesting an increase to 10 bits while outputting 8 bits of sensing data, 10-bit sensing data may be generated and output by controlling the CDAC.

Here, the gain control signal received from the CNN control unit 100 is generated by performing the CNN AI algorithm on sensing data output from the sensor signal processor 300. The CNN control unit 100 uses sensing data output from the sensor signal processor 300 and further workload data as input to generate and output a gain control signal for control of the gain of the TIA 320, the LNA 330, and/or the VGA 370.

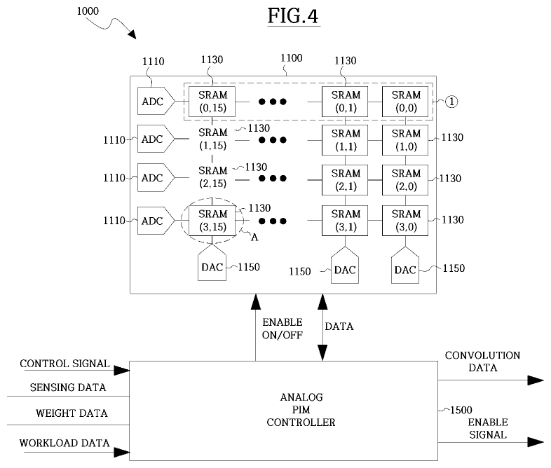

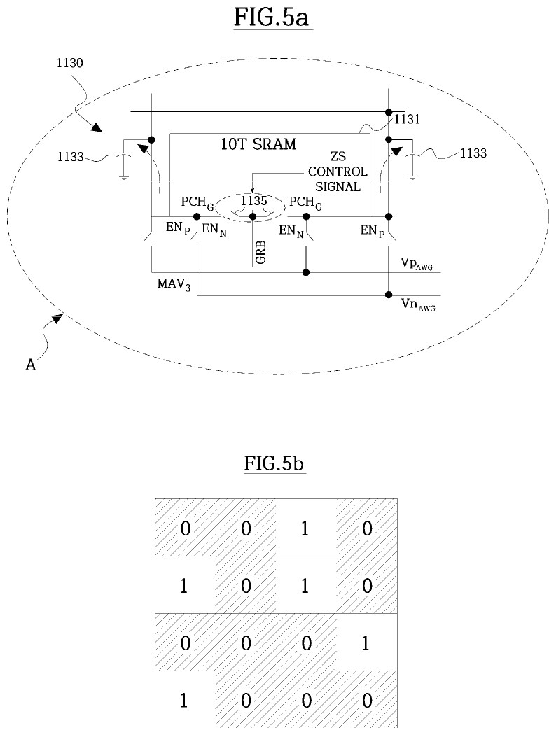

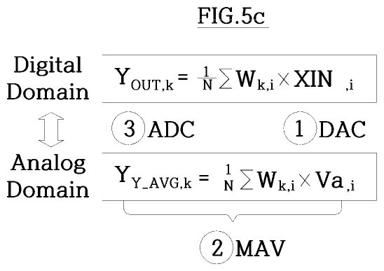

FIG. 4 is a block diagram illustrating a configuration of the analog PIM module 1000, and FIG. 5 is a diagram for describing an internal structure and an operation of the analog PIM.

The analog PIM module 1000 of FIG. 4 configured according to the present invention is configured to be able to perform a convolution operation in the analog signal domain and is configured to be able to dynamically adjust (enlarge or reduce) the resolution of the convolution operation. By using the analog PIM module 1000, which may adjust the computational resolution in a scalable manner, the signal processing circuit 10 is capable of dynamically performing optimal convolution calculations and applying the optimal CNN algorithm accordingly regardless of the type or sort of sensor 30.

Furthermore, the signal processing circuit 10 may reduce power consumption and improve calculation speed by adjusting computational resolution for optimal convolution calculation. The analog PIM module 1000 of FIG. 4 may be configured as an analog PIM circuit and is preferably incorporated in an integrated circuit.

According to FIG. 4, the analog PIM module 1000 includes the analog PIM 1100 and an analog PIM controller 1500. The analog PIM module 1000 of FIG. 4 is preferably incorporated in the signal processing circuit 10 of the sensor device 1, which is an integrated circuit.

The analog PIM 1100 is configured to perform a convolution operation between a weight matrix scaled to a variable size in the analog signal domain (for example, 8*8, 4*4, 3*3, 2*2, 1*1, etc.) and an input data matrix (for example, 8*8, 4*4, 3*3, 2*2, 1*1, etc.).

The analog PIM 1100 includes a plurality of (for example, 8, 16, 64, etc., hereinafter referred to as “first plurality of”) SRAM operators 1130. The first plurality of SRAM operators 1130, which are connected to each other (connected to each other in rows, see 1 of FIG. 4), performs a convolution operation using an SRAM 1131 and a capacitor 1133 therein in the analog domain and generates an analog convolution result signal according to the convolution operation.

Among the first plurality of SRAM operators 1130, the enabled number (for example, 1, 4, 8, 16, etc., hereinafter referred to as “second number”) of SRAM operators 1130 perform a convolution operation under the control of the analog PIM controller 1500. Among the first plurality of SRAM operators 1130, the remaining disabled SRAM operators 1130 suspend performance of the analog convolution operation. Depending on the disable signal, power supply to the SRAM operators 1130 may be suspended or a capacitor 1133 of each of the SRAM operators 1130 may be opened to suspend performance of the convolution operation.

Each of the first plurality of SRAM operators 1130 (temporarily) stores one weight (a weight of 1 or 0) of a weight matrix in the SRAM 1131 and stores one piece of input data of an input data matrix as an analog signal in the capacitor 1133. The SRAM operator 1130 performs a product operation between the weight of the SRAM 1131 and the stored input data of the capacitor 1133 in the analog domain, and the first plurality of SRAM operators 1130 performs an average operation on the product operation using (the total capacity of) provided capacitors 1133 to generate an analog convolution result signal.

The analog PIM 1100 further includes a first plurality of DACs 1150. Each of the first plurality of DACs 1150 is connected to the first plurality of SRAM operators 1130, and the DAC 1150 converts digital input data (for example, workload data or sensing data) into analog input data, and outputs the analog input data to the SRAM operators 1130.

According to the present invention, each of the first plurality of SRAM operators 1130 (one row in FIG. 4) connected to each other includes the SRAM 1131 and one or more (preferably two) capacitors 1133 therein, and includes one or more skip switches 1135 (see a structure of the SRAM operator 1130 of FIG. 5A) configured to control storage of analog input data through the DAC 1150 in the one or more capacitors 1133.

The SRAM 1131 including 10 transistors, etc. stores a weight of a binary signal 1 or 0, and the capacitor 1133 stores analog input data through the connected DAC 1150. The skip switch 1135 may cause the SRAM operator 1130 to store analog input data in the capacitor 1133 according to reception of an on-control signal (zero skip (ZS) control signal) coming from the analog PIM controller 1500, and may cause the SRAM operator 1130 not to store analog input data in the capacitor 1133 according to reception of an off-control signal.

In addition, the analog PIM 1100 further includes one or more ADCs 1110. When the first plurality of SRAM operators 1130 in the analog PIM module 1000 is L SRAM operators 1130 (L being an integer of 1 or more, for example, 4 as shown in FIG. 4), the analog PIM 1100 may have four ADCs 1110.

The ADC 1110 is connected to the first plurality of SRAM operators 1130 in a specific row, converts an analog convolution result signal calculated by the first plurality of SRAM operators 1130 into digital convolution data, and outputs the converted digital convolution data.

The analog PIM controller 1500 of the analog PIM module 1000 controls the analog PIM 1100 so that a convolution operation is performed in the analog domain. The analog PIM controller 1500 includes gates through a logic circuit (for example, a circuit generated according to RTL code) and controls performance of a convolution operation by controlling the analog PIM 1100 according to a control signal received from the CNN control unit 100 of the signal processing circuit 10.

The analog PIM controller 1500 is preferably configured to perform a convolution operation in the analog domain by controlling the enabled second number of SRAM operators 1130 among the first plurality of SRAM operators 1130.

The analog PIM controller 1500 stores weights in the SRAMs 1131 of the enabled second number of SRAM operators 1130 of the first plurality of SRAM operators 1130 and stores input data in the capacitor 1133. The analog PIM controller 1500 stores weights and input data through the DAC 1150 connected to the second number of SRAM operators 1130. When a weight value stored in a weight storage process is a designated value (for example, logic (bit) 0), the analog PIM controller 1500 outputs an open control signal for opening of the skip switch 1135 to the SRAM operator 1130.

By outputting an off-control signal to the SRAM operator 1130, the analog PIM controller 1500 omits performing an analog operation (product operation) in the corresponding SRAM operator 1130. When the stored weight is a different value (for example, logic (bit) 1), the analog PIM controller 1500 outputs an on-control signal to turn on (connect) the skip switch 1135 to the SRAM operator 1130.

By control through the skip switch 1135 further included in the SRAM operator 1130, performance of the analog product operation in the SRAM operator 1130 may be omitted when the weight is 0, so that it is possible to reduce power consumption of the analog PIM 1100 and improve a performance speed of the convolution operation.

FIG. 5B illustrates an example of a weight matrix of size 4*4 (4*4 with the second number being 16). As in the example of FIG. 5B, when a weight of (an element of) a specific row and column of the weight matrix is 0, the skip switch 1135 of the corresponding SRAM operator 1130 is turned off (open) and the corresponding SRAM operator 1130 omits the product operation.

Based on convolution data output from the ADC 1110, the analog PIM controller 1500 outputs enable control signals to the first plurality of SRAM operators 1130 to enable the second number of SRAM operators 1130 less than or equal to the first plurality of SRAM operators 1130 (the second number being 1 or more and less than or equal to the number of the first plurality of SRAM operators 1130) among the entire first plurality of SRAM operators 1130.

The analog PIM controller 1500 outputs enable control signals to the second number of SRAM operators 1130 to activate the second number of SRAM operators 1130 among the first plurality of SRAM operators 1130, and outputs disable control signals to the remaining SRAM operators 1130 to deactivate the remaining SRAM operators 1130 among the first plurality of SRAM operators 1130.

Each disable signal suspends performance of an analog operation (product operation) in each of the remaining SRAM operators 1130. For example, the disable signal blocks power supplied to the SRAM operator 1130 or opens the capacitor 1133 connected to ground through a further provided switch separate from a read/write line (see FIG. 5A).

FIG. 5C illustrates an example formula and a process of a convolution operation performed through the analog PIM 1100 through conversion from the digital domain to the analog domain. Through the DAC 1150, input data (workload data and/or sensor data) and a weight are converted into analog input data and weight and stored in the second number (for example, 16) SRAM operators 1130 (see (of FIG. 5C) among the first plurality of SRAM operators 1130.

Each of the second number (for example, 16) SRAM operators 1130 among the first plurality of SRAM operators 1130 performs a product operation between the SRAM 1131 and the capacitor 1133, and averages signals (for example, voltage signals) according to the capacities of the total capacitors 1133 among the second number (for example, 16) SRAM operators 1130 to generate an analog convolution result signal (see (of FIG. 5C). The ADC 1110 connected to the enabled second number of SRAM operators 1130 converts digital convolution data (see 0 of FIG. 5C) according to the size of the convolution result signal.

The converted digital convolution data is output to the CNN controller 2000 of the CNN control unit 100, and the CNN controller 2000 may extract and classify features according to the CNN AI algorithm.

The analog PIM controller 1500 is preferably configured to dynamically change data used in the convolution operation and the resolution of the operation. The analog PIM controller 1500 is preferably configured to be able to adjust resolution of input data of the SD ADC 390 and/or resolution of the analog convolution operation (second number of SRAM operators 1130) based on input data output from the SD ADC 390 connected to the analog PIM module 1000 and/or convolution data output from the ADC 1110 of the analog PIM 1100.

For example, when input data output from the SD ADC 390 of the sensor signal processor 300 connected to the analog PIM module 1000 is the same a set number of times or more, the analog PIM controller 1500 increases output resolution of the SD ADC 390, and determines the second number of new SRAM operators 1130 to be enabled among the first plurality of SRAM operators 1130 according to convolution data output from the ADC 1110 after the output resolution of the SD ADC 390 is increased.

In addition, the analog PIM controller 1500 interfaces with the analog PIM 1100 to output sensing data from the sensor signal processor 300 or workload data of the power supply to the DAC 1150 connected to the second number of SRAM operators 1130 selected as input data and output a weight from the CNN controller 2000 to the DAC 1150 connected to the second number of SRAM operators 1130. In addition, the analog PIM controller 1500 may output convolution data output through the ADC 1110 to the CNN controller 2000.

The analog PIM controller 1500 (or the CNN controller 2000) periodically samples input data according to a sampling period (and event) according to the determined second number, stores the sampled input data in the analog PIM 1100, and then allows an analog convolution operation to be performed. In this way, the analog PIM controller 1500 outputs input data adjusted according to the second number changed through determination to the changed second number of SRAM operators 1130. In addition, the analog PIM controller 1500 receives weight data adjusted according to the changed second number from the CNN controller 2000 and outputs an adjusted weight to the second number of SRAM operators 1130.

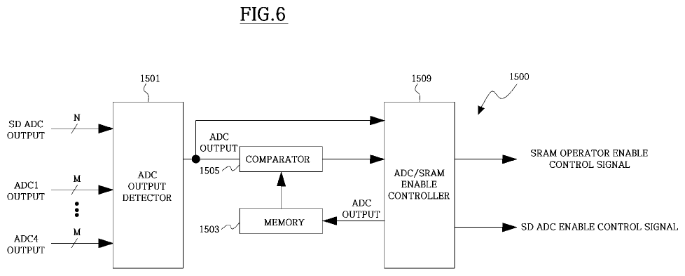

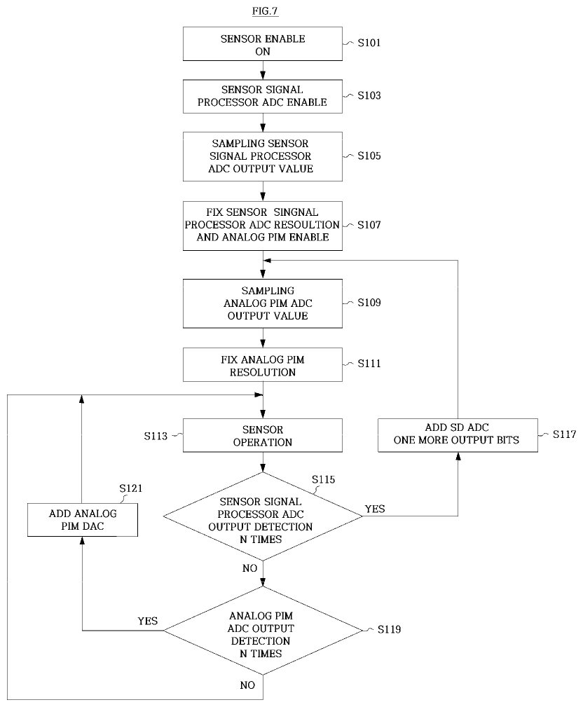

FIG. 6 is a diagram illustrating an example block diagram of the analog PIM controller 1500.

According to FIG. 6, the analog PIM controller 1500 includes an ADC output detector 1501, a comparator 1505, a memory 1503, and an ADC/SRAM enable controller 1509. The analog PIM controller 1500 of FIG. 6 includes a logic circuit (for example, a circuit generated according to RTL code) and is implemented as an integrated circuit through a plurality of gates.

The ADC output detector 1501 detects convolution data output from the ADC 1110 of the analog PIM 1100 and further detects input data (sensing data) output from the SD ADC 390 of the sensor signal processor 300 connected to the analog PIM module 1000. The ADC output detector 1501 may detect data upon receipt of a signal representing data output from the CNN controller 2000, other control logic of the analog PIM controller 1500, and/or the sensor signal processor 300. The ADC output detector 1501 outputs the detected data (convolution data or input data).

The memory 1503 stores previous input data and previous convolution data output to the ADC output detector 1501.

The comparator 1505 digitally compares convolution data output from the ADC output detector 1501 with convolution data output before (immediately before), and outputs a comparison result signal. In addition, the comparator 1505 further digitally compares input data output from the ADC output detector 1501 with input data output according to previous (immediately before) detection and outputs a comparison result signal.

The comparator 1505 outputs a comparison result signal indicating whether data from the memory 1503 and data output from the ADC output detector 1501 are the same through comparison for each of convolution data and input data.

According to a comparison result in the comparator 1505, the ADC/SRAM enable controller 1509 determines the number bits of the SD ADC 390 and the second number to be used for an analog convolution operation among the first plurality of SRAM operators 1130. The ADC/SRAM enable controller 1509 generates an enable (control) signal and outputs the enable (control) signal to the SD ADC 390 to increase the resolution of the SD ADC 390 according to a comparison between current data (input data or convolution data) and previous data, and generates an enable (control) signal and outputs the enable (control) signal to the second number of SRAM operators 1130 of the analog PIM 1100 to increase the resolution of the convolution operation.

For example, when the ADC/SRAM enable controller 1509 continuously receives the same comparison result signal through the comparator 1505 a designated number of times (for example, 4 times, 5 times, etc.) or more set for convolution data, the ADC/SRAM enable controller 1509 determines a second number greater than the currently set second number to increase resolution of an analog operation of the first plurality of SRAM operators 1130. For example, when there is a total of 64 SRAM operators 1130 and four of the SRAM operators 1130 are currently used, the ADC/SRAM enable controller 1509 increases the second number from 4 to 5 (or 8, 9, etc.). The designated number of times may be set by the control terminal 2.

The ADC/SRAM enable controller 1509 outputs an enable control signal to the first plurality of SRAM operators 1130 to enable the increasing second number of SRAM operators 1130. The ADC/SRAM enable controller 1509 outputs enable signals to the second number of SRAM operators 1130 to enable the increased second number of SRAM operators 1130 among the first plurality of SRAM operators 1130, and outputs disable signals to the remaining SRAM operators 1130 to disable the remaining SRAM operators 1130.

Through this process, the analog PIM module 1000 may perform a convolution operation matching the sensors 30 or optimized for the conditions of the sensors 30 while reducing power consumption by increasing analog computational resolution in real time when output resolution is low for a convolution operation on input data.

In addition, the ADC/SRAM enable controller 1509 increases output resolution of the SD ADC 390 according to a comparison result of input data through the comparator 1505. When the ADC/SRAM enable controller 1509 continuously receives the same comparison result signal a designated number of times (for example, 4 times, 5 times, etc.) or more set for input data, the ADC/SRAM enable controller 1509 outputs an enable control signal to the SD ADC 390 to have output resolution higher than currently set output resolution. The ADC/SRAM enable controller 1509 outputs an enable control signal to the SD ADC 390 to enable a larger number of bits (for example, a 1 bit increase) than a currently set number of bits of the SD ADC 390. The designation number may be set by the control terminal 2, and the designation number used for input data and the designation number used for convolution data may be different from each other.

The SD ADC 390 controls the internal CDAC, etc. upon reception of an enable control signal and outputs digital sensing data having resolution of an increased number of bits.

Following the increase in the number of output bits of the SD ADC 390, the ADC/SRAM enable controller 1509 re-determines the second number enabled in the first plurality of SRAM operators 1130 using convolution data output through the ADC 1110 of the analog PIM 1100. When the ADC/SRAM enable controller 1509 continuously receives the same comparison result signal a designated number of times (for example, 4 times, 5 times, etc.) or more set for convolution data through the comparator 1505 starting from the minimum number (for example, 1) of the first plurality thereof, the ADC/SRAM enable controller 1509 determines a second number greater than a currently set second number to increase resolution of an analog operation of the first plurality of SRAM operators 1130.

The ADC/SRAM enable controller 1509 performs a process of determining the second number repeatedly or simultaneously (in parallel) to detect resolution of an optimal convolution operation while output resolution of the SD ADC 390 is changed, thereby allowing an optimized CNN AI algorithm to be performed according to the connected sensors 30 or the conditions of the sensors 30.

The ADC/SRAM enable controller 1509 outputs an enable control signal to the first plurality of SRAM operators 1130 to enable the second number of SRAM operators 1130, and outputs an enable control signal for activating the second number of DACs 1150 connected to the second number of SRAM operators 1130. In addition, the ADC/SRAM enable controller 1509 may output disable control signals to the remaining DACs 1150 among the first plurality of DACs 1150 to deactivate the remaining DACs 1150.

A resolution determination process performed in the ADC/SRAM enable controller 1509 will be examined in more detail with reference to FIG. 7.

FIG. 7 is a flowchart for describing an illustrative control flow for determining output and computational resolution matching any sensor 30.

The control flow of FIG. 7 for controlling the analog PIM 1100 is performed in the signal processing circuit 10 and is preferably performed by control of the CNN control unit 100 and (the analog PIM controller 1500 of) the analog PIM module 1000. Since the signal processing circuit 10 has already been examined in detail through FIGS. 1 to 6, the control flow will be focused upon and examined more below.

First, the signal processing circuit 10 enables the sensors 30 (S101). The signal processing circuit 10 may start or initialize operations of the sensors 30 by supplying power to the sensors 30 according to a POR (Power On Reset) signal applied from the outside or generated according to power supply. The signal processing circuit 10 also initializes the internal circuits 100, 200, and 300.

Thereafter, the signal processing circuit 10 enables the SD ADC 390 of the sensor signal processor 300 (S103). For example, the signal processing circuit 10 enables the SD ADC 390 so that the SD ADC 390 has output resolution of all bits.

The signal processing circuit 10 samples input data (sensing data) output from the SD ADC 390 of the sensor signal processor 300 (S105) and determines resolution of the SD ADC 390 from the sampled input data (S107).

The signal processing circuit 10 samples input data a plurality of number of times, and determines, as initial resolution of the SD ADC 390, the number of bits changing less than a designated number of times from between a minimum number of bits (for example, 1 bit) of the SD ADC 390 and a maximum number of bits (for example, the number of bits of maximum resolution that may be output by the SD ADC 390, such as 16 bits or 32 bits) using the comparator 1505. The signal processing circuit 10 may determine the initial resolution by sequential performance for each number of bits, or may determine the initial resolution through parallel determination for all bits.

The signal processing circuit 10 outputs an enable control signal to the SD ADC 390 to enable the number of bits determined according to the initial resolution, and the SD ADC 390 outputs digital sensing data according to the set resolution.

Following determination of the initial (initial) resolution, the signal processing circuit 10 enables the analog PIM 1100 (S107). The CNN controller 2000 may initialize the analog PIM 1100 by controlling the analog PIM controller 1500.

After enabling the analog PIM 1100, the signal processing circuit 10 samples convolution data output from the ADC 1110 of the analog PIM 1100 (S109) and determines resolution of the analog PIM from the sampled convolution data (S111).

The signal processing circuit 10 may conduct comparison testing of convolution data sequentially from the minimum resolution (the second number is 1) to the maximum resolution (the second number is the first plurality) under the control of the CNN controller 2000, and determine computational resolution of the first (initial) analog PIM 1100 according to comparison testing.

The signal processing circuit 10 may perform a convolution operation on a weight and input data (sensing data) at currently set resolution between the minimum resolution and the maximum resolution, increase the currently set resolution when digital convolution data, which is a result of the convolution operation, is the same a designated number of times or more, and determine initial optimal computational resolution by repeatedly comparing current convolution data with previous convolution data at the increased resolution. Through this test process, the signal processing circuit 10 determines the initial second number.

After determining the number of bits of the SD ADC 390 and the second number according to the initialization process (see S101 to S111), the signal processing circuit 10 dynamically adjusts the number of bits of the SD ADC 390 and the second number according to output of the SD ADC 390 or the ADC 1110 of the analog PIM 1100 to maintain optimal resolution required for the convolution operation in real time and optimize power consumption.

More specifically, after determining the number of bits of the SD ADC 390 and the second number (see S101 to S111), the signal processing circuit 10 performs a sensor operation under control by the CNN control unit 100 (S113).

The signal processing circuit 10 generates an analog convolution result signal according to an analog operation between a weight and input data (for example, sensing data) in one or more enabled second number of SRAM operators 1130 among the first plurality of SRAM operators 1130 through the analog PIM 1100, and converts a convolution result signal generated through the ADC 1110 of the analog PIM 1100 into digital convolution data. The signal processing circuit 10 may perform the CNN AI algorithm in real time using the converted convolution data.

A process of generating a convolution result signal is configured to omit an analog operation (product operation) through the skip switch 1135 according to an off-control signal received from the analog PIM controller 1500 and set according to a value of a weight in one or more second number of SRAM operators 1130.

Following the sensor operation, the signal processing circuit 10 determines whether digital input data output from the sensor signal processor 300 is the same a set number of times or more (S115). When the digital input data is the same a designated number of times or more, the signal processing circuit 10 determines that the output resolution of the sensor signal processor 300 is low and increases output resolution of the input data (S117).

The signal processing circuit 10 increases the currently set number of output bits of the SD ADC 390 by 1 or more and outputs an enable control signal indicating the increased number of bits to the SD ADC 390.

Following an increase in output resolution of input data (according to an increase in the number of bits of the SD ADC 390), the signal processing circuit 10 re-performs S109 and S111 to sequentially increase the second number of SRAM operators 1130 enabled between the minimum number and the number of the first plurality thereof, and re-determines the second number through a comparison between convolution data output from the increased second number of SRAM operators 1130 and convolution data of the previous same second number. Through this process, when the number of output bits of the SD ADC 390 changes, resolution of an optimal analog operation is dynamically calculated to optimize performance of the CNN AI algorithm.

In addition, the signal processing circuit 10 dynamically determines the second number of SRAM operators 1130 to be enabled among the first plurality of SRAM operators 1130 based on convolution data output from the analog PIM 1100 (S119 and S121). When convolution data output from the analog PIM 1100 is the same as previous convolution data (successively) a designated number of times or more (S119), the signal processing circuit 10 increases the second number to increase computational resolution of the first plurality of SRAM operators 1130 (S121).

The signal processing circuit 10 determines a second number greater than a currently determined second number, enables the determined second number of SRAM operators 1130 (and the corresponding DACs 1150), and performs a subsequent sensor operation accordingly. The signal processing circuit 10 may output an enable control signal for enabling the changed second number of SRAM operators 1130 (and the corresponding second number of DACs 1150) to the first plurality of SRAM operators 1130 (and the corresponding second number of DACs 1150) and output convolution results of computational resolution adjusted through the activated SRAM operators 1130 and the DACs 1150.

Through the above control flow, the signal processing circuit 10 may process the sensors 30 by being universally combined with the sensors 30 regardless of the type of sensors 30, and have dynamically efficient convolution operation processing and optimized power consumption depending on the type or condition of the sensors 30.

Hereinafter, as another embodiment of the monitoring system, a system that includes multiple sensors and monitors abnormal conditions based on multiple sensors will be described.

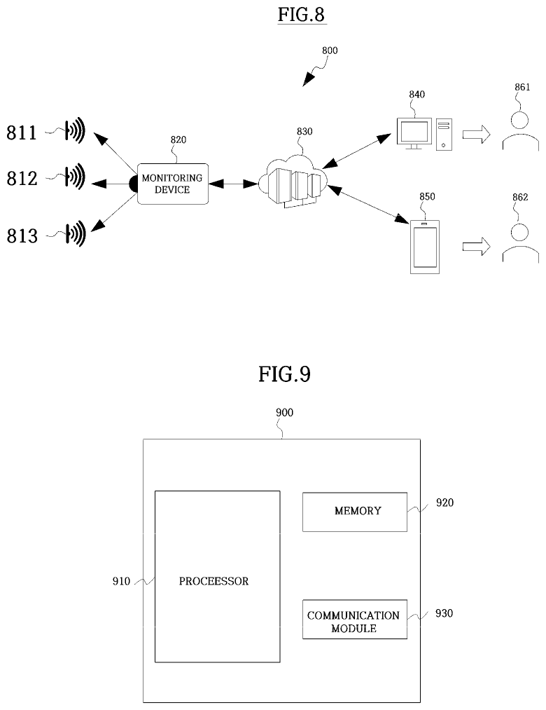

FIG. 8 is a diagram for describing an example of a system for monitoring an abnormal condition based on multiple sensors according to an embodiment.

Referring to FIG. 8, the system 800 for monitoring an abnormal condition based on multiple sensors (hereinafter referred to as monitoring system) may include a plurality of sensors 811, 812, and 813, a monitoring device 820, a server 830, and one or more user terminals 840 and 850. However, in addition thereto, the monitoring system 800 may further include at least one external device. Respective components included in the monitoring system 800 may be connected through wired or wireless communication to transmit and receive data therebetween.

The plurality of sensors 811, 812, and 813 may be sensors used to construct an Internet of Things (IoT) system. For example, the plurality of sensors 811, 812, and 813 may detect various objects or phenomena in various environments and situations in the area where the IoT system is constructed. For example, each of the plurality of sensors 811, 812, and 813 may be any one of a temperature sensor, a humidity sensor, a motion sensor, a gas sensor, a vibration sensor, an illumination sensor, a noise sensor, a distance sensor, a pressure sensor, a proximity sensor, a pH sensor, a UV sensor, a magnetic sensor, an image sensor, a sound sensor, a wind speed sensor, a wind direction sensor, a current sensor, a voltage sensor, and a flow sensor. In addition, the sensors of the monitoring system 800 may include sensors configured to detect objects related to the IoT system.

With regard to FIG. 8, objects detected by each sensor may be objects related to an abnormal condition monitored by the monitoring system 800. Here, the abnormal condition monitored by the monitoring system 800 may mean a condition that exceeds a normal range due to a change in the environment in which the IoT system or the monitoring system 800 operates. For example, the monitoring system 800 may monitor whether an abnormal condition such as fire or gas leak occurs around an area where the monitoring system 800 is constructed (or the area where the IoT system is constructed) based on changes in temperature, pressure, and gas detected by the temperature sensor, the pressure sensor, and the gas sensor, respectively.

Meanwhile, the area where the monitoring system 800 is constructed may be a target area where whether an abnormal condition occurs is monitored by the monitoring system 800. In other words, the plurality of sensors 811, 812, and 813 may be installed in the target area where the abnormal condition is monitored to detect objects related to the abnormal condition, respectively. Meanwhile, even though the plurality of sensors 811, 812, and 813 is installed in the target area, a detection range may vary depending on the type of object being detected. Therefore, depending on the type of object detected by the sensor, the monitoring system 800 may include a plurality of sensors that detect the same object. For example, the monitoring system 800 may include a first gas sensor, a second gas sensor, and a temperature sensor. However, for convenience of description, even when a plurality of sensors detecting the same object is installed in the target area, the sensors detecting the object are grouped and described as one sensor.

In the present disclosure, the plurality of sensors 811, 812, and 813 may not be limited to sensors that detect one object. For example, the plurality of sensors 811, 812, and 813 may each be a sensor that selectively detects one object or a sensor that simultaneously detects a plurality of objects. In other words, in the sensors included in the monitoring system 800, each sensor detecting a specific object may be implemented as an independent device or implemented as a device capable of performing both a function of detecting one object and a function of detecting another object. As an example, the monitoring system 800 may include a gas sensor, a pressure sensor, and a temperature sensor that detect gas, pressure, and temperature, respectively. As another example, the monitoring system 800 may include a first sensor configured to detect gas and a second sensor configured to detect pressure and temperature.

Meanwhile, the plurality of sensors 811, 812, and 813 may each be the sensor 30 of FIG. 1. For example, the plurality of sensors 811, 812, and 813 may be devices installed in the target area of the monitoring system 800 to sense the external environment. The plurality of sensors 811, 812, and 813 may operate according to supplied power to detect objects related to abnormal conditions and output sensing signals related to the results of detecting the objects.

The monitoring device 820 may be connected to the plurality of sensors 811, 812, and 813 included in the monitoring system 800 to receive sensing signals from the plurality of sensors 811, 812, and 813. In other words, the monitoring device 820 may receive sensing signals detecting different types of objects. For example, in the present disclosure, a first sensing signal related to a first object detected by the first sensor and a second sensing signal related to a second object detected by the second sensor may be processed by the monitoring device 820 rather than being received and processed by independent devices.

The monitoring device 820 may output a monitoring result related to whether an abnormal condition occurs in the target area based on processing of the received sensing signals. In more detail, the monitoring device 820 may convert a sensing signal into input data to be input to a neural network model, and perform an operation on the input data using a neural network model to acquire a monitoring result related to abnormal condition classification. Meanwhile, an example of a specific operation of the monitoring device 820 in the present disclosure will be described with reference to FIGS. 9 to 15 below.

The server 830 may be a device configured to communicate with external devices including the monitoring device 820 and the user terminals 840 and 850. For example, the server 830 may receive a monitoring result from the monitoring device 820 and store the monitoring result. In addition, the server 830 may transmit the stored monitoring result to the user terminal 840 belonging to a manager 861 or the user terminal 850 belonging to an IoT system user 862.

The user terminals 840 and 850 may be computing devices each having a display device and including a memory and a processor. For example, the display device may be implemented as a touchscreen to receive user input. Alternatively, each of the user terminals 840 and 850 may further include a separate device (for example, a keyboard, a mouse, etc.) that receives user input. For example, the user terminals 840 and 850 may include, but are not limited to, a smartphone, a notebook PC, a desktop PC, a laptop PC, a tablet computer, etc.

The user terminal 840 of the manager 861, which manages the monitoring system 800 (or IoT system), may output condition information of the IoT system according to a monitoring result in response to receiving a monitoring result from the server 830. For example, through the user terminal 840, the manager 861 may verify whether the environment around the current IoT system is in a normal condition or whether an abnormal condition has occurred with respect to a predetermined object, or receive an alarm with regard to occurrence of an abnormal condition. Similarly, the user terminal 850 of the user 862 using the IoT system may output condition information of the IoT system according to a monitoring result in response to receiving a monitoring result from the server 830. Similarly, through the user terminal 850, the user 862 may verify whether the environment around the current IoT system is in a normal condition or whether an abnormal condition has occurred with respect to a predetermined object, or receive an alarm with regard to occurrence of an abnormal condition. Meanwhile, referring to FIG. 8, the user terminals 840 and 850 are shown as receiving monitoring results from the server 830. However, the present invention is not limited thereto. The user terminals 840 and 850 may receive monitoring results directly from the monitoring device 820 or may receive monitoring results from another device (not shown).

FIG. 9 is a diagram for describing an example of an internal configuration of a monitoring device according to an embodiment.

Referring to FIG. 9, the monitoring device 900 may include a processor 910, a memory 920, an input/output interface 930, and a communication module 940. For convenience of description, only components related to the present invention are shown in FIG. 9. Accordingly, in addition to the components shown in FIG. 9, other general-purpose components may be further included in the monitoring device 900. In addition, it is obvious to those skilled in the art related to the present invention that the processor 910, the memory 920, the input/output interface 930, and the communication module 940 shown in FIG. 9 may be implemented as independent devices.

The processor 910 may process computer program instructions by performing basic arithmetic, logic, and input/output operations. Here, the instructions may be provided from the memory 920 or an external device (for example, an external server, etc.). In addition, the processor 910 may generally control operations of other components included in the monitoring device 900.

The processor 910 may determine an operation mode based on condition information in the target area in which an abnormal condition is monitored.

For example, the processor 910 may determine, as an operation mode, any one of a first mode in which different objects are simultaneously detected or a second mode in which an object related to condition information is detected in real time.

### (First Operation Mode)

The processor 910 may receive sensing signals from a plurality of sensors installed in the target area in response to the first mode in which different objects are simultaneously detected being determined as the operation mode.

Here, the plurality of sensors may include at least one of the gas sensor, the pressure sensor, or the temperature sensor.

The processor 910 may process the sensing signals and output first sensing data obtained by converting the sensing signals into digital signals.

For example, the processor 910 may select one of the sensing signals based on a first selection control signal, amplify the selected sensing signal based on an amplification control signal and a gain control signal, and perform digital conversion on the amplified sensing signal to output sensing data.

According to an embodiment, the first selection control signal may be a signal configured to perform a control operation to select sensing signals in time series.

According to an embodiment, the first selection control signal may be a signal configured to perform a control operation to select one of the sensing signals based on a predetermined period.

The processor 910 may generate first input data to be input to a first neural network model by variably adjusting the size of the first sensing data.

For example, the processor 910 may accumulate the first sensing data to correspond to the number of bits and generate the first input data having output resolution corresponding to the number of bits based on an enable signal that specifies the number of bits enabled in the maximum resolution.

The processor 910 may perform an operation in the analog domain on the first input data using the first neural network model and output first operation data obtained by converting an operation result into digital data.

For example, the processor 910 may convert the first input data into an input value in the analog domain, perform a convolution operation in the analog domain on the input value using a plurality of SRAM operators, and output the first operation data obtained by converting an analog convolution result, which is an output value of the operation, into data in the digital domain.

The processor 910 may output a first monitoring result obtained by classifying an abnormal condition based on the first operation data.

For example, the processor 910 may classify an abnormal condition for each of objects detected by a plurality of sensors and output a monitoring result based on an abnormal condition classification result for each object.

According to one embodiment, the processor 910 may determine a category of an abnormal condition based on the abnormal condition classification result for each object, and output a monitoring result by classifying a risk level within the determined category of the abnormal condition.

According to an embodiment, the processor 910 may assign a weight to one of the objects detected by the plurality of sensors and assign a weight to an abnormal condition classification result for the weighted object.

According to an embodiment, the processor 910 may update the condition information in the target area based on the first monitoring result.

### (Second Operation Mode)

The processor 910 may select a target sensor from among the plurality of sensors installed in the target area in response to the second mode in which an object related to condition information is detected in real time being determined as the operation mode.

Here, the plurality of sensors may include at least one of the gas sensor, the pressure sensor, or the temperature sensor.

For example, the processor 910 may select a sensor that detects a main object related to condition information as a main target sensor among a plurality of sensors, and select a sensor that detects a sub-object related to the main object as a sub-target sensor.

The processor 910 may process a target signal received from the target sensor and output second sensing data obtained by converting the target signal into a digital signal.

For example, the processor 910 may receive a target signal from a target sensor based on a second selection control signal in response to a target sensor being selected, amplify the target signal based on an amplification control signal and a gain control signal, and perform digital conversion on the amplified target signal to output second sensing data.

The processor 910 may generate second input data to be input to a second neural network model by variably adjusting the size of the second sensing data.

For example, the processor 910 may accumulate the second sensing data to correspond to the number of bits and generate the second input data having output resolution corresponding to the number of bits based on an enable signal that specifies the number of bits enabled in the maximum resolution.

Here, the second neural network model is a model used in response to the second mode being determined as the operation mode, and may be characterized as a model that performs an operation by considering input data at a time before a time of performing the operation.

The processor 910 may perform an operation in the analog domain on second input data using the second neural network model and output second operation data obtained by converting an operation result into digital data.

For example, the processor 910 may convert the second input data into a second input value in the analog domain, perform a convolution operation in the analog domain on the second input value using a plurality of SRAM operators, and output second operation data obtained by converting a second analog convolution result, which is an output value of the operation, into data in the digital domain.

The processor 910 may output a second monitoring result obtained by classifying an abnormal condition based on the second operation data.

For example, the processor 910 may determine a category of an abnormal condition in response to an object detected by a target sensor, and output a second monitoring result by classifying a risk level within the determined category of the abnormal condition.

According to an embodiment, the processor 910 may determine a category of an abnormal condition based on an abnormal condition classification result for each of a main object and a sub-object, and output a second monitoring result in consideration of risk level classification for the main object and risk level classification for the sub-object within the determined category of the abnormal condition.

According to an embodiment, the processor 910 may update the condition information in the target area based on the second monitoring result.

The processor 910 may be implemented as an array of a plurality of logic gates, or may be implemented as a combination of a general-purpose microprocessor and a memory storing a program executable on the microprocessor. For example, the processor 910 may include a general-purpose processor, a central processing unit (CPU), a microprocessor, a digital signal processor (DSP), a controller, a microcontroller, a state machine, etc. In some circumstances, the processor 910 may include an application specific integrated circuit (ASIC), a programmable logic device (PLD), a field programmable gate array (FPGA), etc. For example, the processor 910 may refer to a combination of a DSP and a microprocessor, a combination of a plurality of microprocessors, a combination of one or more microprocessors combined with a DSP core, or a combination of processing devices, such as a combination of any other such configurations.

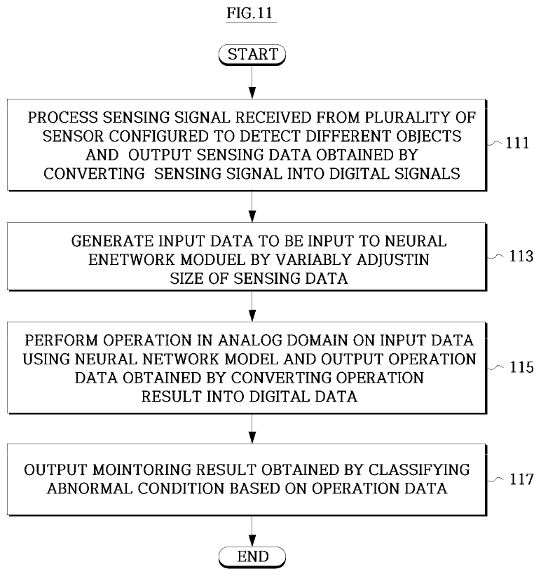

The memory 920 may include any non-transitory computer-readable recording medium. As an example, the memory 920 may include a random access memory (RAM) and a permanent mass storage device such as a read only memory (ROM), a disk drive, a solid state drive (SSD), or a flash memory. As another example, the permanent mass storage device such as the ROM, the SSD, the flash memory, or the disk drives may be a separate persistent storage device distinct from a memory. In addition, an operating system (OS) and at least one piece of program code (for example, code for the processor 910 to perform an operation to be described later with reference to FIGS. 11 to 15) may be stored in the memory 920.

These software components may be loaded from a recording medium readable by a computer separate from the memory 920. The recording medium readable by this separate computer may be a recording medium directly connectable to the monitoring device 900. For example, the recording medium may include a computer-readable recording medium such as a floppy drive, a disk, a tape, a DVD/CD-ROM drive, or a memory card. Alternatively, software components may be loaded into the memory 920 through the communication module 940 rather than the computer-readable recording medium. For example, at least one program may be loaded into the memory 920 based on a computer program installed by files provided through the communication module 940 by developers or a file distribution system that distributes application installation files (for example, a computer program for the processor 910 to perform operations to be described later with reference to FIGS. 11 to 15, etc.).

The communication module 930 may provide a configuration or function for the plurality of sensors 811, 812, and 813 and the server 830 to communicate with the monitoring device 900 through a network. In addition, the communication module 940 may provide a configuration or function for the monitoring device 900 to communicate with other external devices (for example, the user terminals 840 and 850). For example, control signals, commands, data, etc. provided under control of the processor 910 may be transmitted to the server 830 and/or an external device through the communication module 940 and the network.

Meanwhile, according to an embodiment, although not shown in FIG. 9, the monitoring device 900 may further include a display device. Alternatively, the monitoring device 900 may be connected to an independent display device through wired or wireless communication to transmit and receive data therebetween. For example, the display device may display condition information in the target area according to a monitoring result.

According to another embodiment, the monitoring device 900 may further include an input/output interface. The input/output interface may be a means for interfacing with a device for input or output (for example, a keyboard, a mouse, etc.) that may be connected to the monitoring device 900 or included in the monitoring device 900. The input/output interface may be implemented as an element configured separately from the processor 910, or may be configured to be included in the processor 910.

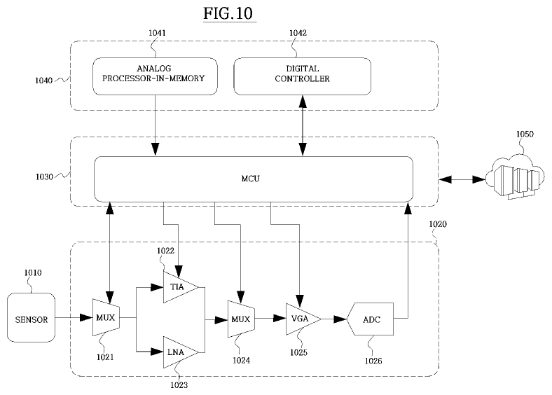

FIG. 10 is a diagram for describing another example of the internal configuration of the monitoring device according to an embodiment.

Referring to FIG. 10, the monitoring device may include a sensor signal processing unit 1020, a microcontroller unit (MCU) 1030, and an analog PIM unit 1040.

According to an embodiment, the sensor signal processing unit 1020 may correspond to the sensor signal processor 300 described in FIGS. 1 to 7. A part of the operation performed by the sensor signal processor 300 described in FIGS. 1 to 7 may be performed by the sensor signal processing unit 1020.

For example, the sensor signal processing unit 1020 may include a first MUX 1021 (multiplex), a TIA 1022, an LNA 1023, a second MUX 1024, a VGA 1025, and an SDADC 1026. These may correspond to the first MUX 310 (multiplex), the TIA 320, the LNA 330, the second MUX 350, the VGA 370, and the SDADC 390 of the sensor signal processor 300, respectively.

For example, the first MUX 1021 and the second MUX 1024 may receive signals and select signals. The TIA 1022 may convert a sensing signal in the form of a current signal into a voltage signal based on a first amplification control signal. The LNA 1023 may amplify a sensing signal in the form of a voltage signal to minimize noise based on a second amplification control signal. The VGA 1025 may amplify a voltage signal based on a dynamically adjusted gain control signal. The SD ADC 1026 may perform digital conversion on the amplified sensing signal and output sensing data. For example, the SD ADC 1026 may convert an analog sensing signal into a digital signal and output the converted sensing data.

According to an embodiment, the sensor signal processing unit 1020 may receive sensing signals from a plurality of sensors installed in the target area in response to the first mode in which different objects are simultaneously detected is determined as the operation mode.

According to an embodiment, the sensor signal processing unit 1020 may select a target sensor from among a plurality of sensors installed in the target area in response to the second mode in which an object related to condition information is detected in real time is determined as the operation mode.

Here, the plurality of sensors may include at least one of the gas sensor, the pressure sensor, or the temperature sensor.

According to an embodiment, the sensor signal processing unit 1020 may select one of sensing signals based on the first selection control signal, amplify the selected sensing signal based on an amplification control signal and a gain control signal, and perform digital conversion on the amplified sensing signal to output sensing data.

According to an embodiment, the first selection control signal may be a signal configured to perform a control operation to select sensing signals in time series.

According to an embodiment, the first selection control signal may be a signal configured to perform a control operation to select one of the sensing signals based on a predetermined period.

According to an embodiment, the sensor signal processing unit 1020 may select a sensor that detects a main object related to condition information as a main target sensor among a plurality of sensors, and select a sensor that detects a sub-object related to the main object as a sub-target sensor. The sensor signal processing unit 1020 may process a target signal received from the target sensor and output second sensing data obtained by converting the target signal into a digital signal.

According to an embodiment, in response to the target sensor selected, the sensor signal processing unit 1020 may receive a target signal from the target sensor based on the second selection control signal, amplify the target signal based on the amplification control signal and the gain control signal, and perform digital conversion on the amplified target signal to output second sensing data.

According to an embodiment, the sensor signal processing unit 1020 may generate first input data to be input to the first neural network model by variably adjusting the size of the first sensing data. Alternatively, the sensor signal processing unit 1020 may generate second input data to be input to the second neural network model by variably adjusting the size of the second sensing data. For example, the sensor signal processing unit 1020 may accumulate the first sensing data (or the second sensing data) to correspond to the number of bits and generate the first input data (or the second input data) having output resolution corresponding to the number of bits based on an enable signal that specifies the number of bits enabled in the maximum resolution.

According to an embodiment, the MCU 1030 may correspond to the CNN controller 2000 described in FIGS. 1 to 7. A of the operation performed by the CNN controller 2000 described in FIGS. 1 to 7 may be performed by the MCU 1030.

According to an embodiment, the MCU 1030 may determine an operation mode based on condition information in the target area where an abnormal condition is monitored. For example, the MCU 1030 may determine, as the operation mode, any one of the first mode in which different objects are simultaneously detected and the second mode in which an object related to condition information is detected in real time.

According to an embodiment, the MCU 1030 may output a first monitoring result obtained by classifying an abnormal condition based on the first operation data.

For example, the MCU 1030 may classify an abnormal condition for each of objects detected by a plurality of sensors and output a monitoring result based on an abnormal condition classification result for each object.

According to an embodiment, the MCU 1030 may determine a category of the abnormal condition based on the abnormal condition classification result for each object, and output a monitoring result by classifying a risk level within the determined category of the abnormal condition.

According to an embodiment, the MCU 1030 may assign a weight to one of the objects detected by the plurality of sensors and assign a weight to an abnormal condition classification result for the weighted object.

According to an embodiment, the MCU 1030 may output a second monitoring result obtained by classifying an abnormal condition based on the second operation data.

For example, the MCU 1030 may determine a category of an abnormal condition in response to an object detected by the target sensor, and output a second monitoring result by classifying a risk level within the determined category of the abnormal condition.

According to an embodiment, the MCU 1030 may determine a category of an abnormal condition based on an abnormal condition classification result for each of a main object and a sub-object, and output a second monitoring result in consideration of risk level classification for the main object and the risk level classification for the sub-object within the determined category of the abnormal condition.

According to an embodiment, the MCU 1030 may update the condition information in the target area based on the first monitoring result or the second monitoring result.

The analog PIM unit 1040 may include an analog PIM (Analog Processor in Memory) 1041 and a digital controller 1042. Here, the analog PIM 1041 may correspond to the analog PIM 1100 described in FIGS. 1 to 7. A part of the operation performed by the analog PIM 1100 described in FIGS. 1 to 7 may be performed by the analog PIM 1041. In addition, the digital controller 1042 may correspond to the analog PIM controller 1500 described in FIGS. 1 to 7. A part of the operation performed by the analog PIM controller 1500 described in FIGS. 1 to 7 may be performed by the digital controller 1042.

According to an embodiment, the analog PIM unit 1040 may perform an operation in the analog domain on first input data using the first neural network model and output first operation data obtained by converting an operation result into digital data.

For example, the analog PIM unit 1040 may convert the first input data into an input value in the analog domain, perform a convolution operation in the analog domain on the input value using a plurality of SRAM operators, and output the first operation data obtained by converting an analog convolution result, which is an output value of the operation, into data in the digital domain.

According to an embodiment, the analog PIM unit 1040 may perform an operation in the analog domain on second input data using the second neural network model and output second operation data obtained by converting an operation result into digital data.

For example, the analog PIM unit 1040 may convert the second input data into an input value in the analog domain, perform a convolution operation in the analog domain on the input value using a plurality of SRAM operators, and output the second operation data obtained by converting an analog convolution result, which is an output value of the operation, into data in the digital domain.

FIG. 11 is a flowchart for describing an example of a method of monitoring an abnormal condition based on multiple sensors according to an embodiment.

In step 111, the monitoring device may process sensing signals received from a plurality of sensors that detect different objects and output sensing data obtained by converting the sensing signals into digital signals.

The plurality of sensors may be sensors that detect objects related to the IoT system, as described above with reference to FIG. 8. In addition, the objects detected by the plurality of sensors, respectively, may be objects related to an abnormal condition monitored by the monitoring system.

For example, the monitoring device may receive sensing signals from the gas sensor, the pressure sensor, and the temperature sensor. In other words, the plurality of sensors may include at least one of the gas sensor, the pressure sensor, or the temperature sensor.

Meanwhile, even though one sensor is described as detecting a specific object for convenience of description, the present invention is not limited thereto. For example, when the monitoring device receives a sensing signal related to gas from the gas sensor, the monitoring device may receive sensing signals related to gas from a plurality of gas sensors. In other words, the monitoring system may include a plurality of gas sensors each configured to detect gas.

The monitoring device may output sensing data as a result of signal processing for the sensing signals through a processing process of selecting one of the sensing signals, amplifying the selected sensing signal, and performing digital conversion on the amplified sensing signal.

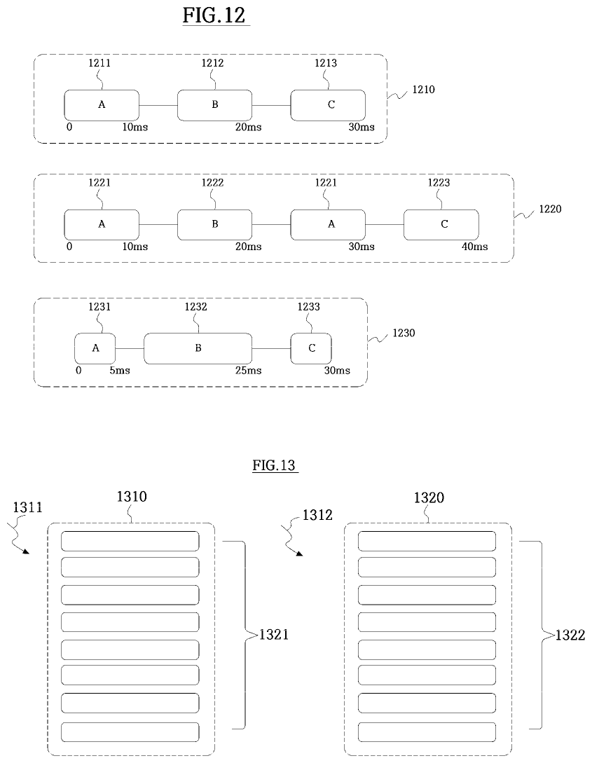

In more detail, the monitoring device may select one of the received sensing signals based on a selection control signal. In relation thereto, a method of select a sensing signal by the monitoring device will be described with reference to FIG. 12.

FIG. 12 is a diagram for describing examples of sensing data according to an embodiment.

Referring to a first signal processing example 1210, a second signal processing example 1220, and a third signal processing example 1230 shown in FIG. 12, the monitoring device may receive a sensing signal A, a sensing signal B, and a sensing signal C from a plurality of sensors that detect different objects.

In the present disclosure, since the monitoring device simultaneously monitors a plurality of sensors, that is, simultaneously performs signal processing on sensing signals received from the plurality of sensors, it may be necessary to assign priorities as to which of the received sensing signals will be processed first.

According to an embodiment, the selection control signal may be a signal configured to perform a control operation to select sensing signals in time series. In other words, the monitoring device may select one of the sensing signals over time. For example, when the monitoring device receives sensing signals from a plurality of sensors during a predetermined time, the monitoring device may divide the predetermined time and select a sensing signal to be received during each time interval.

According to an embodiment, the selection control signal may be a signal configured to perform a control operation to select one of the sensing signals based on a predetermined period. For example, the predetermined period may be a value preset by the manager or the user of the monitoring system. For example, in the first signal processing example 1210, the monitoring device may select one of the received sensing signals based on a selection control signal configured to perform a control operation to perform selection based on a period of 10 ms. Accordingly, the monitoring device may select a sensing signal A 1211 from 0 seconds to 10 ms, a sensing signal B 1212 from 10 ms to 20 ms, and a sensing signal C 1213 from 20 ms to 30 ms.

Here, the selection control signal may be a signal that controls selection of sensing signals so that a frequency at which each of the sensing signals is selected is adjusted. In more detail, the frequency at which each of the sensing signals is selected may be determined based on a weight assigned to each of the sensing signals. For example, in the second signal processing example 1220, the monitoring device may assign the greatest weight to the sensing signal A 1221 among the received sensing signals, and a sensing signal may be selected based on a selection control signal that controls selection of the sensing signals so that the sensing signal A 1221 is selected at the highest frequency. Accordingly, in the second signal processing example 1220, the monitoring device may select the sensing signal A 1211 from 0 seconds to 10 ms, the sensing signal B 1212 from 10 ms to 20 ms, the sensing signal A 1211 again from 20 seconds to 30 ms, and the sensing signal C 1213 from 30 ms to 40 ms.

Meanwhile, a weight for each of the sensing signals may be assigned based on an importance of an object of a sensing signal, that is, an object detected by a sensor in relation to an abnormal condition. For example, when an importance of monitoring temperature is high, a high weight may be assigned to the temperature sensor or a sensing signal received from the temperature sensor. As another example, when an importance of monitoring gas is high, a high weight may be assigned to the gas sensor or a sensing signal received from the gas sensor.

According to another embodiment, the selection control signal may be a signal that controls selection of signals so that a time interval at which a signal is received is adjusted for each of the sensing signals. In more detail, the time interval at which each of the sensing signals is received may be determined based on a weight assigned to each of the sensing signals. For example, in the third signal processing example 1230, the monitoring device may assign the greatest weight to the sensing signal B 1232 among the received sensing signals, and thus may select a sensing signal based on a selection control signal that controls selection of sensing signals so that a time interval at which the sensing signal B 1232 is received is the longest. Accordingly, in the third signal processing example 1230, the monitoring device may select a sensing signal A 1231 from 0 seconds to 5 ms, a sensing signal B 1232 from 5 ms to 25 ms, and a sensing signal C 1233 from 25 ms to 30 ms.

Meanwhile, each of the sensing signals 1211, 1212, 1213, etc. shown in the first signal processing example 1210, the second signal processing example 1220, and the third signal processing example 1230 of FIG. 12 may refer to sensing data converted into a digital signal. For example, in the first signal processing example 1210, the sensing data A may be sensing data obtained by amplifying the sensing signal A based on an amplification control and gain control signal and performing digital conversion on the amplified sensing signal. Likewise, the sensing data B and the sensing data C may each be sensing data in digital form. That is, in the first signal processing example 1210, sequence data connected in time series may be data obtained by connecting digital sensing data. The monitoring device may use the corresponding sequence data to generate input data for input to a neural network model. In relation thereto, a description will be given again below.

Meanwhile, the monitoring device may adjust a signal level of a sensing signal, which is an analog signal, before converting the received sensing signals into digital signals. For example, since an analog sensing signal received from the gas sensor and an analog sensing signal received from the temperature sensor have different signal levels (or signal magnitudes, etc.), the monitoring device may adjust the signal levels to satisfy an input condition for converting each sensing signal into a digital signal. To this end, the monitoring device may amplify a selected sensing signal based on an amplification control signal and a gain control signal. As an example, the monitoring device may convert a sensing signal in the form of a current signal into a voltage signal based on a first amplification control signal and amplify the converted voltage signal based on a dynamically adjusted gain control signal. As another example, the monitoring device may amplify a sensing signal in the form of a voltage signal to minimize noise based on a second amplification control signal and may amplify the sensing signal based on a dynamically adjusted gain control signal.

The monitoring device may output sensing data by performing digital conversion on the amplified sensing signal. For example, the monitoring device may convert an analog sensing signal into a digital signal and output the converted sensing data.

Referring again to FIG. 11, in step 113, the monitoring device may generate input data to be input to the neural network model by variably adjusting the size of the sensing data.

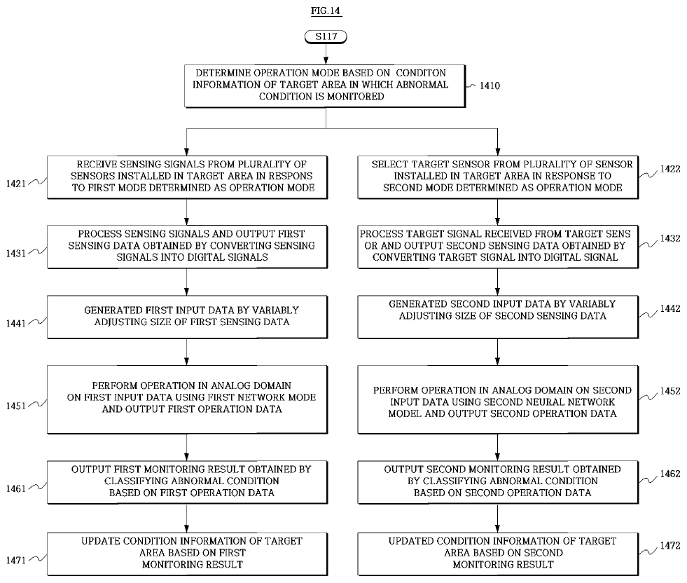

With regard to step 113, a more detailed description will be given with reference to FIG. 13.

FIG. 13 is a diagram for describing examples of input data according to an embodiment.

Sensing data refers to data obtained by converting sensing signals into digital signals, as described above. For example, the monitoring device may generate sequence data by connecting sensing data, and adjust the size of the sequence data to correspond to the size for input to a neural network model to generate input data.

For example, the monitoring device may accumulate sensing data to correspond to the number of bits based on an enable signal that specifies the number of bits enabled within the maximum resolution, and generate input data having output resolution corresponding to the number of bits. For example, the monitoring device may generate input data using digital sensing data within the maximum resolution with a maximum resolution of 8 bits, 16 bits, or 32 bits.

As an example, the monitoring device may accumulate (or connect to sequence data) sensing data 1321 based on a first enable signal 1311 to generate first input data 1310. Here, the first enable signal 1311 may be an enable signal that specifies the number of bits (maximum number of bits) corresponding to the maximum resolution. In other words, the monitoring device may generate the first input data 1310 by accumulating the sensing data 1321 up to the maximum number of bits.

As another example, the monitoring device may accumulate (or connect to sequence data) sensing data 1322 based on a second enable signal 1312 to generate second input data 1320. Here, the second enable signal 1312 may be an enable signal that specifies the number of bits corresponding to a resolution lower than the maximum resolution. In other words, the monitoring device may generate the second input data 1320 by accumulating the sensing data 1322 up to a predetermined number of bits.

Referring again to FIG. 11, in step 115, the monitoring device may perform an operation in the analog domain on input data using a neural network model and output operation data obtained by converting an operation result into digital data.

For example, the monitoring device may convert input data into an input value in the analog domain. In other words, the monitoring device may convert digital input data into an input value, which is analog input data, and output the converted input value to the SRAM operator.

In addition, the monitoring device may perform a convolution operation in the analog domain for an input value using a plurality of SRAM operators. Here, a structure and operation method of the plurality of SRAM operators have been described in detail with reference to FIG. 4.

In addition, the monitoring device may output operation data obtained by converting an analog convolution result, which is an output value of a convolution operation in the analog domain, into data in the digital domain. For example, the monitoring device may convert an analog convolution result signal calculated by the SRAM operator into operation data, which is digital convolution data, and output the converted operation data.

Meanwhile, according to an embodiment, the monitoring device may include the analog PIM unit 1040. As described above in FIG. 10, at least some of the operations described as being performed by the analog PIM module 1000, the analog PIM 1100, and the analog PIM controller 1500 in FIGS. 1 to 7 are performed by the monitoring device.

Referring again to FIG. 11, in step 117, the monitoring device may output a monitoring result obtained by classifying an abnormal condition based on calculation data.

For example, the monitoring device may classify an abnormal condition for each of objects detected by a plurality of sensors and output a monitoring result based on an abnormal condition classification result for each object.

An example of monitoring results output based on sensing signals received from the gas sensor, the temperature sensor, and the pressure sensor will be described with reference to the following Table 1.

TABLE 1

| | | | Monitoring | |
|---|---|---|---|---|
| Gas | Temperature | Pressure | result | Class |
| Normal | Normal | Normal | Normal | 1 |
| Abnormality | Abnormality | Normal | Fire | 2 |
| detected | detected | | abnormality | |
| | | | detected | |
| Abnormality | Normal | Abnormality | Gas leak | 3 |
| detected | | detected | abnormality | |
| | | | detected | |
| Abnormality | Normal | Normal | Harmful gas | 4 |
| detected | | | detected | |
| Risk | Abnormality | Abnormality | Initial gas | 5 |
| | detected | detected | leak, risk of | |
| | | | initial fire | |
| Risk | Risk | Normal | Risk of fire | 6 |
| Risk | Normal | Abnormality | Risk of | 7 |
| | | detected | initial gas | |
| | | | leak | |
| Risk | Normal | Risk | Risk of gas | 8 |
| | | | leak | |
| Risk | Abnormality | Normal | Risk of early | 9 |
| | detected | | fire | |

For example, referring to Table 1, the monitoring device may classify an abnormal condition for each of gas, temperature, and pressure detected by the gas sensor, the temperature sensor, and the pressure sensor as any one of normal, abnormality detected, and risk. In addition, the monitoring device may output a monitoring result such as fire risk based on an abnormal condition classification result for each object.

Meanwhile, according to an embodiment, the monitoring device may determine a category of the abnormal condition based on the abnormal condition classification result for each object. For example, the monitoring device may determine the category of the abnormal condition to be a category related to fire, in response to an abnormal condition classification result for fire being any one of abnormality detected or risk.

In addition, the monitoring device may output a monitoring result by classifying a risk level within the category of the determined abnormal condition. For example, the monitoring device may classify a risk level as risk of initial fire in response to an abnormal condition classification result for fire being abnormality detected, and may classify a risk level as risk of fire in response to an abnormal condition classification result for fire being risk.

According to another embodiment, the monitoring device may assign a weight to any one object among objects detected by a plurality of sensors and assign a weight to an abnormal condition classification result for any one weighted object. For example, the monitoring device may determine fire as a category of the abnormal condition comprehensively considering an abnormal condition classification result for temperature detected by the temperature sensor and an abnormal condition classification result for gas detected by the gas sensor, or determine gas leak as a category of the abnormal condition comprehensively considering an abnormal condition classification result for gas detected by the gas sensor and an abnormal condition classification result for pressure detected by the pressure sensor. However, an abnormal condition related to fire and an abnormal condition related to gas leak have a strong relationship with temperature (or an abnormal condition classification result for temperature) and gas (or an abnormal condition classification result for gas), respectively, and thus the monitoring device may assign weight to the corresponding object (or an abnormal condition classification result for the object). For example, the monitoring device may determine a category of the abnormal condition or classify a risk level of the abnormal condition by further considering the weight applied to the object (or the abnormal condition classification result for the object).

FIG. 14 is a flowchart for describing another example of the method of monitoring an abnormal condition based on multiple sensors according to an embodiment.

Referring to FIG. 14, in step 1410, the monitoring device may determine an operation mode based on condition information of a target area where an abnormal condition is monitored.

Here, the condition information in the target area refers to condition information related to an area where an abnormal condition is monitored through a plurality of sensors. For example, when any one of objects detected by a plurality of sensors deviates from a normal condition, the condition information in the target area may be in an abnormal detection condition. Specifically, the condition information in the target area may be a monitoring result including a category, a risk level, etc. of an object deviating from the normal condition.

Alternatively, when all objects detected by the plurality of sensors are in the normal condition, the condition information in the target area may be in the normal condition. Here, a normal state of an object may refer to a normal condition, and the fact that an object is out of the normal condition may mean that a risk level for the object is an abnormality detected condition or a risk condition.

For example, the monitoring device may determine the first mode in which different objects are simultaneously detected may be determined as the operation mode in response to condition information in the target area being the normal condition. As another example, the monitoring device may determine the second mode in which an object related to condition information is detected in real time as the operation mode in response to the condition information in the target area being the abnormality detected condition.

Hereinafter, steps 1421, 1431, 1441, 1451, 1461, and 1471 illustrate an example of an operational flow of the monitoring device operating in the first mode, and steps 1422, 1432, 1442, 1452, 1462, and 1472 illustrate an example of an operational flow of the monitoring device operating in the second mode. Meanwhile, hereinafter, the operation of the monitoring device operating in the first mode may include a part of the operation of the monitoring device described in FIG. 11. Accordingly, the operation of the monitoring device described in FIG. 11 may be included in the operation of the monitoring device operating in the first mode in FIG. 14.

In step 1421, the monitoring device may receive sensing signals from a plurality of sensors installed in the target area in response to the first mode being determined as the operation mode.

In step 1431, the monitoring device may process the sensing signals and output first sensing data obtained by converting the sensing signals into digital signals.

In step 1441, the monitoring device may generate first input data to be input to the first neural network model by variably adjusting the size of the first sensing data.

In step 1451, the monitoring device may perform an operation on the analog domain on the first input data using the first neural network model and output first operation data obtained by converting an operation result into digital data.

In step 1461, the monitoring device may output a first monitoring result obtained by classifying an abnormal condition based on the first operation data.

In step 1471, according to an embodiment, the monitoring device may update the condition information in the target area based on the first monitoring result. For example, when the condition information in the target area is updated with (maintained at) the normal condition, the monitoring device may operate in the first operation mode. Alternatively, when the condition information in the target area is updated with (or changed to) the abnormality detected condition, the monitoring device may operate in the second operation mode.

Again, in step 1422, the monitoring device may select a target sensor from among a plurality of sensors installed in the target area in response to the second mode in which an object related to condition information is detected in real time being determined as the operation mode.

That is, the target sensor may be a sensor that detects an object related to condition information. For example, when the condition information in the target area is a condition of risk of initial fire, the monitoring device may determine the second mode as the operation mode and select the temperature sensor as the target sensor to monitor the temperature sensor related to fire in real time.

Meanwhile, according to an embodiment, the monitoring device may select a sensor that detects a main object related to condition information as a main target sensor among a plurality of sensors, and select a sensor that detects a sub-object related to the main object as a sub-target sensor.

For example, when the condition information in the target area is a condition of risk of initial fire, the monitoring device may determine temperature as the main object to select the temperature sensor as the main target sensor, and determine gas related to temperature as the sub-object to determine the gas sensor as the sub-target sensor. In other words, according to an embodiment, even when operating in the second mode, the monitoring device may detect an object in which an abnormal condition is found in real time and continuously monitor an object associated with the corresponding object.

Thereafter, in step 1432, the monitoring device may process the target signal received from the target sensor and output second sensing data obtained by converting the target signal into a digital signal.

Meanwhile, the processing process for outputting the second sensing data based on the target signal may be the same as the processing process for outputting the sensing data based on the sensing signal described in FIG. 11. Accordingly, overlapping descriptions will be omitted. For example, the monitoring device may amplify the target signal based on the amplification control signal and the gain control signal in the same manner as described in FIG. 11 or perform digital conversion on the amplified target signal to output second sensing data.

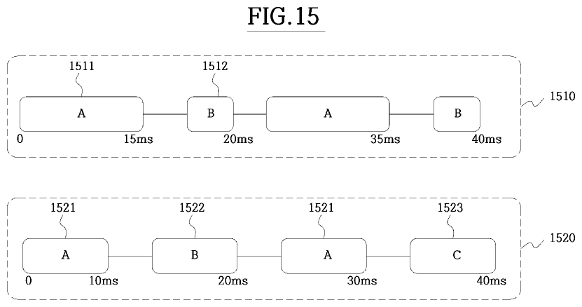

According to an embodiment, the monitoring device may receive a target signal from the target sensor based on the second selection control signal in response to the target sensor being selected. In relation thereto, a description will be given with reference to FIG. 15.

FIG. 15 is a diagram for describing other examples of the sensing data according to an embodiment.

Referring to a first signal processing example 1510 and a second signal processing example 1520 shown in FIG. 15, the monitoring device may receive a target signal from a target sensor. Here, target signals A 1511 and 1521 may be main target signals received from the main target sensor, and a target signal 1522 and a target signal C 1523 may be sub-target signals received from the sub-target sensor.

The embodiments described with respect to the selection control signal in FIG. 11 may be applied to the second selection control signal without change. As an example, the second selection control signal may be a signal configured to perform a control operation to select the target signal in time series. As another example, the second selection control signal may be a signal configured to perform a control operation to select the target signal based on a predetermined period.

According to another embodiment, the second selection control signal may be a signal that controls selection of signals so that time intervals at which the main target signal and the sub-target signal are received are differently adjusted. For example, in the first signal processing example 1510, the monitoring device may select target signals so that a time interval at which the target signal A 1511, which is the main target signal, is selected is longer than a time interval at which the target signal B 1512, which is the sub-target signal, is selected based on the second selection control signal. Accordingly, the monitoring device may select the target signal A 1511 from 0 ms to 15 ms and the target signal B 1512 from 15 ms to 20 ms.

According to still another embodiment, the second selection control signal may be a signal that controls selection of target signals so that frequencies at which the main target signal and the sub-target signal are selected are adjusted. For example, in the second signal processing example 1520, the monitoring device may select target signals so that a frequency at which the target signal A 1521, which is the main target signal, is selected is higher than frequencies at which the target signal B 1522 and the target signal C 1523, which are sub-target signals, are selected based on the second selection control signal. Accordingly, the monitoring device may select the target signal A 1521 from 0 ms to 10 ms, the target signal B 1522 from 10 ms to 20 ms, the target signal A 1521 again from 20 ms to 30 ms, and the target signal C 1523 from 30 ms to 40 ms.

Referring again to FIG. 14, in step 1442, the monitoring device may generate second input data to be input to the second neural network model by variably adjusting the size of the second sensing data.

Meanwhile, a process of generating input data based on sensing data may be the same as the process described with reference to FIG. 11, and thus a redundant description will be omitted. For example, based on an enable signal that specifies the number of bits enabled within the maximum resolution, the monitoring device may accumulate the second sensing data to correspond to the number of bits and generate second data having output resolution corresponding to the number of bits.

According to an embodiment, in response to the second mode determined as the operation mode, the monitoring device may change a neural network model to be used from the first neural network model used when the operation mode is the first mode to the second neural network model. Here, the second neural network model may be characterized as a model that performs an operation by considering input data at a time prior to a time at which the operation is performed. That is, according to the embodiment, the second neural network model is a neural network model having a circular structure, and when the second neural network model is used, continuity or order over time may be taken into consideration, and thus the second neural network may be more suitable for the second operation mode in which a target sensor is intensively monitored.

For example, the first neural network model may be a CNN model, and the second neural network model may be an RNN model. Meanwhile, examples of the second neural network model are not limited to the RNN model, and any model having a recurrent neural network structure, such as a Long Short Term Memory (LSTM) model or a Gated Recurrent Unit (GRU) model, may correspond to the second neural network model.

Thereafter, in step 1452, the monitoring device may perform an operation in the analog domain on the second input data using the second neural network model and output second operation data obtained by converting an operation result into digital data. Likewise, a process of performing an operation on the second input data using the second neural network model may be the same as the operation process described with reference to FIG. 11, and thus a redundant description will be omitted.

For example, the monitoring device may convert second input data into a second input value in the analog domain, perform a convolution operation in the analog domain on the second input value using a plurality of SRAM operators, and output second operation data obtained by converting a second analog convolution result, which is an output value of the operation, into data in the digital domain.

Thereafter, in step 1462, the monitoring device may output a second monitoring result obtained by classifying an abnormal condition based on the second operation data. Likewise, a process of outputting the second monitoring result with regard to the target sensor may be the same as the process of outputting the first monitoring result described with reference to FIG. 11, and thus a redundant description will be omitted.

For example, the monitoring device may determine a category of an abnormal condition in response to an object detected by the target sensor, and output the second monitoring result by classifying a risk level within the determined category of the abnormal condition. For example, when the target sensor is the temperature sensor, the monitoring device may determine fire related to temperature as the category of abnormal condition. In addition, the monitoring device may classify a risk level with regard to fire as safe, initial risk level, risk level, etc. based on processing the target signal received from the temperature sensor.

According to an embodiment, the monitoring device may determine the category of the abnormal condition based on an abnormal condition classification result for each of the main object related to the condition information and the sub-object related to the main object. For example, when the main object is temperature and the sub-object is gas, the monitoring device may determine fire, etc. as the category of abnormal condition.

In addition, the monitoring device may output the second monitoring result by considering risk level classification for the main object and risk level classification for the sub-object within the category of the abnormal condition. In more detail, the monitoring device may assign a higher weight to risk level classification for the main object than that of risk level classification for the sub-object. For example, when the risk level for the main object and the risk level for the sub-object are both a safe level, the monitoring device may output information indicating that the target area is in the normal condition as the second monitoring result. As another example, in the case of monitoring an abnormal condition related to fire, when a risk level related to temperature (main object) is initial risk and a risk level related to gas (sub object) is risk, the monitoring device may output information indicating that the target area is at risk of initial fire as the second monitoring result. As another example, when a risk level related to temperature (main object) is risk and a risk level related to gas (sub object) is initial risk, the monitoring device may output information indicating that the target area is at risk of fire as the second monitoring result.

Referring again to FIG. 14, in step 1472, the monitoring device may update the condition information in the target area based on the second monitoring result.

For example, when the condition information in the target area is updated with (changed to) the normal condition, the monitoring device may operate in the first operation mode. Alternatively, when the condition information in the target area is updated with (or maintained at) the abnormality detected condition, the monitoring device may operate in the second operation mode.

Unless there is an explicit statement of order or statement to the contrary with regard to the steps included in the method according to the invention, the steps may be performed in any suitable order. The present invention is not necessarily limited by the stated order of the steps. Any examples or illustrative terms (for example, etc.) in the present invention are merely used to describe the present invention in detail, and unless limited by the claims, the scope of the present invention is not limited by the examples or illustrative terms. In addition, those skilled in the art will recognize that various modifications, combinations, and changes may be made depending on design conditions and factors within the scope of the appended claims or equivalents thereto.

Therefore, the spirit of the present invention should not be limited to the above-described embodiments, and not only the claims described below but also all scopes equivalent to or equivalently changed from the claims fall within the scope of the spirit of the present invention.

What is claimed is:

1. A method of monitoring an abnormal condition based on multiple sensors, the method comprising:
processing sensing signals received from a plurality of sensors configured to detect different objects and outputting sensing data obtained by converting the sensing signals into digital signals;
generating input data to be input to a neural network model by variably adjusting a size of the sensing data;
performing an operation in an analog domain on the input data using the neural network mode and outputting operation data obtained by converting an operation result into digital data; and
outputting a monitoring result obtained by classifying an abnormal condition based on the operation data.

2. The method according to claim 1, wherein the plurality of sensors includes at least one of a gas sensor, a pressure sensor, or a temperature sensor.

3. The method according to claim 1, wherein the outputting sensing data comprises:
selecting one of the sensing signals based on a selection control signal;
amplifying the selected sensing signal based on an amplification control signal and a gain control signal; and
performing digital conversion on the amplified sensing signal to output the sensing data.

4. The method according to claim 3, wherein the selection control signal is a signal configured to perform a control operation to select the sensing signals in time series.

5. The method according to claim 3, wherein the selection control signal is a signal configured to perform a control operation to select any one of the sensing signals based on a predetermined period.

6. The method according to claim 1, wherein the generating input data comprises accumulating the sensing data to correspond to a number of bits enabled within a maximum resolution based on an enable signal that specifies the number of bits, and generating the input data having an output resolution corresponding to the number of bits.

7. The method according to claim 1, wherein the outputting operation data comprises:
converting the input data into an input value in the analog domain;
performing a convolution operation in the analog domain on the input value using a plurality of SRAM operators; and
outputting the operation data obtained by converting an analog convolution result, which is an output value of the operation, into data in the digital domain.

8. The method according to claim 1, wherein the outputting a monitoring result comprises:
classifying an abnormal condition for each of the objects detected by the plurality of sensors; and
outputting the monitoring result based on an abnormal condition classification result for each of the objects.

9. The method according to claim 8, wherein the outputting a monitoring result comprises:
determining a category of the abnormal condition based on the abnormal condition classification result for each of the objects; and
outputting the monitoring result by classifying a risk level within the determined category of the abnormal condition.

10. The method according to claim 8, further comprising assigning a weight to any one of the objects detected by the plurality of sensors and assigning a weight to an abnormal condition classification result for the one weighted object.

11. An abnormal condition monitoring device based on multiple sensors, comprising:
a memory configured to store at least one program; and
a processor configured to execute the at least one program, wherein the processor is configured to:
process sensing signals received from a plurality of sensors configured to detect different objects and output sensing data obtained by converting the sensing signals into digital signals,
generate input data to be input to a neural network model by variably adjusting a size of the sensing data,
perform an operation in an analog domain on the input data using the neural network mode and output operation data obtained by converting an operation result into digital data, and
output a monitoring result obtained by classifying an abnormal condition based on the operation data.

12. A computer-readable recording medium on which is stored a program for executing the method according to claim 1 on a computer.
